(19) United States
(12) Patent Application Publication
(10) Pub. No.: US 2021/0058334 A1
(43) Pub. Date: Feb. 25, 2021

(54) TIMESTAMP-BASED FAIRNESS EGRESS FROM INGRESS QUEUES

(71) Applicant: Intel Corporation, Santa Clara, CA (US)

(72) Inventors: John GRETH, Hudson, MA (US); Arvind SRINIVASAN, San Jose, CA (US); David ARDITTI ILITZKY, Zapopan (MX); Robert SOUTHWORTH, Chatsworth, CA (US); Gaspar MORA PORTA, Santa Clara, CA (US); Scott DIESING, Round Rock, TX (US); Bongjin JUNG, Westford, MA (US); Prasad SHABADI, North Andover, MA (US)

(21) Appl. No.: 16/547,482

(22) Filed: Aug. 21, 2019

(51) Int. Cl. H04L 12/867; H04L 12/911; H04L 12/863; H04L 12/865

(52) U.S. Cl. CPC H04L 47/629; H04L 47/826; H04L 47/6275; H04L 47/6255; H04L 47/624

(57) ABSTRACT

Examples described herein provide a packet ingress and egress system with a memory buffer in a network device. The ingress and egress system can generate a time stamp for one or more received packets at an ingress port, allocate a received packet to a queue among multiple queues, and permit egress of a packet from a queue. An ingress port can have one or more queues allocated to store received packets. An egress port can use the one or more queues from which to egress packets. A maximum size of a queue is set as the allocated memory region size divided by the number of ingress ports that use the allocated memory region. An egress arbiter can apply an arbitration scheme to schedule egress of packets in time stamp order.

### TECHNICAL FIELD

Various examples described herein relate to managing congestion at ingress ports of a switch.

### BACKGROUND

In the field of data communications, switches are used to receive packets at one or more ingress ports and route packets to an egress port for transmission to an intermediate node or destination. In some cases, queues are used to store packets before egressing from an egress port. Egress ports have allocated bandwidth that is shared among one or more queues and one or more ingress ports. In some cases, it is desirable for switch bandwidth to be shared evenly across ingress ports regardless of how those ingress ports are physically grouped or which egress ports the traffic is flowing to. However, this can be difficult to accomplish in high radix switches with high number of ingress and egress ports and which use port groups.

### BRIEF DESCRIPTION OF THE DRAWINGS

FIG. 1 depicts a high-level block diagram of a system for ingressing and egressing packets.

FIG. 2 shows bandwidth allocated to each ingress port for various schemes given the environment of FIG. 1.

FIGS. 3A and 3B depict examples of egress based on packet time stamps.

FIG. 4A depicts an example of egress bandwidth allocation for an incast scenario.

FIG. 4B shows an example of egress bandwidth allocation for the example of FIG. 4A.

FIG. 4C depicts an example of queue size allocation.

FIG. 4D depicts a scenario where each input port feeds a different number of queues, and each queue is fed by a different number of ports.

FIG. 4E depicts a scenario with the edges showing the share of each input port going to a queue.

FIG. 4F depicts another example.

FIG. 5 depicts an example system to provide allocate a packet to a queue and egress packets.

FIG. 6 shows the bandwidth consumed in a scenario of FIG. 4A.

FIG. 7 depicts an example process.

FIG. 8 depicts a system.

FIG. 9 depicts an example of a data center.

FIG. 10 depicts an environment

### DETAILED DESCRIPTION

At each egress port, fairness scheduling is applied to queues to determine which packets to egress. Fairness scheduling typically favors ingress ports which are sending traffic to many egress ports. When an ingress port is sending traffic to all egress ports, each individual egress port will see a small portion of requested bandwidth. But the ingress port will be able to consume all the requested bandwidth. By contrast, an ingress port that targets a small number of egress ports will be throttled.

In addition, this solution does not scale. For example, in a case where there are 256 ingress ports, 256 egress ports, and 16 traffic classes, there are over one million queues. The number of queues is not feasible given limited available memory and fair scheduling can work for a switch with fewer ingress ports and egress ports. To cap a number of queues to a feasible number, ingress ports can be grouped and share virtual queues. Virtual queues driven by more ingress ports should therefore get more bandwidth than other virtual queues which are driven by fewer ingress ports.

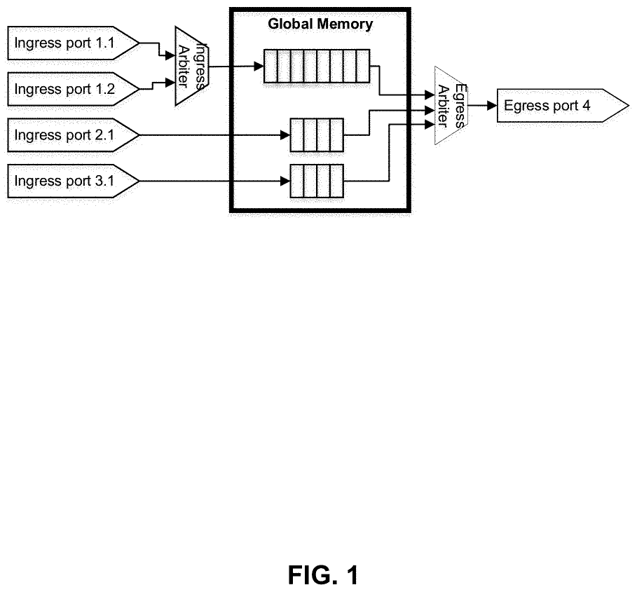

FIG. 1 depicts a high-level block diagram of a system for ingressing and egressing packets. The ingress ports 1.1 and 1.2 are grouped into a pair to reduce the number of separate queues. Ingress ports 2.1 and 3.1 have separate allocated queues. In this example, all of the ingress ports are sending traffic to the same egress port, egress port 4. Traffic from ingress ports 1.1 and 1.2 is first routed through an ingress arbiter. The ingress arbiter feeds a single queue which holds packets from a group of ingress ports which are destined for the same egress port. The ingress arbiter will ensure that the queue is shared equally between a group including ingress ports 1.1 and 1.2. When there is only one ingress port in a group targeting a given egress port (as is the case for 2.1 and 3.1), the ingress arbitration simply passes the data along to a queue. The queueing system allocates space to each queue such that memory is shared evenly across ingress ports. When more than one ingress port is feeding a single queue, that queue is allowed to grow.

Packet traffic is read from the queueing system by an egress arbiter. The egress arbiter uses timestamps associated with the traffic and sends the oldest packet first. This results in more bandwidth allocated to the larger queue. This can be a desired outcome, because ingress ports 1.1 and 1.2 combined should get twice as much bandwidth as ingress port 2.1 or 3.1 alone.

In this example, a global memory has 16 spots for ingress data from 4 ingress ports. 16 spots are allocated evenly such that each ingress port gets 4 spots. If 2 ingress ports share a queue, the queue gets two times a number of spots. The shared queue has twice the number of spots as the non-shared second and third queues. Time stamp arbitration provides two times bandwidth to the shared queue. The ingress arbiter fairly shares bandwidth among ingress ports whereas the egress arbiter fairly shares bandwidth among the queues for round robin egress arbitration. As there are three queues but four ingress ports, ingress ports 2.1 and 3.1 each receive one-third of the egress bandwidth but ingress ports 1.1 and 1.2 each receive half of one-third of egress bandwidth. Accordingly, by sharing a queue, ports 1.1 and 1.2 receive less egress bandwidth than if they had not shared a queue, despite the shared queue being twice as large as any unshared queue. Round robin egress arbitration allocates bandwidth to queues in a way that is fair to queues. Timestamp egress arbitration allocates bandwidth to queues in a way that is fair to ingress ports.

FIG. 1 shows an example where egress arbitration allocates bandwidth to queues and that the global memory allocates queueing spots in a way that is fair to ingress ports, but does not depict a specific implementation of the egress arbiter. If the egress arbiter in FIG. 1 is implemented as round robin egress arbitration, bandwidth will be fair to queues and unfair to ingress ports. If the egress arbiter in FIG. 1 is implemented as timestamp egress arbitration, bandwidth will be fair to ingress ports and unfair to queues. It can be desirable for egress bandwidth to be shared fairly across all ingress ports even though some ingress ports are grouped and share a queue.

Various embodiments provide an egress scheduling system that determines a time stamp for one or more received packets based on time of arrival. Time stamp can be set at arrival time at a port or when copied to a queue. A received packet can be allocated to a receive queue and a receive queue can be shared by one or more input ports. However, an amount of queueing for an ingress port is capped at the queue space in memory allocated to that port. A shared memory can be partitioned so that each ingress port has a maximum amount of space. However, every ingress port can have the same amount of space. For example, a 400Gbps ingress port will generally receive 4 times the memory allocation as a 100 Gbps ingress port. For a selected traffic class (TC) or flow to egress, egress of packets can be scheduled in time stamp order. Various embodiments provides fair bandwidth allocation across all ingress ports without adding significant overhead. Ingress ports can share a queue and still be allocated a share of the egress bandwidth that is proportional to the number of ingress ports.

When a packet arrives from ingress port or when packet copied from an ingress port into a queue, a time stamp can be determined and assigned to the packet. Packet tags and descriptor can indicate where packet data is stored in memory and also a packet time stamp. The time stamp can be used to determine which packet data to fetch from a queue for egress. The egress arbiter attempts to schedule egress in time stamp order. In some examples, time stamp-based arbitration can allocate output bandwidth in proportion to queue depth.

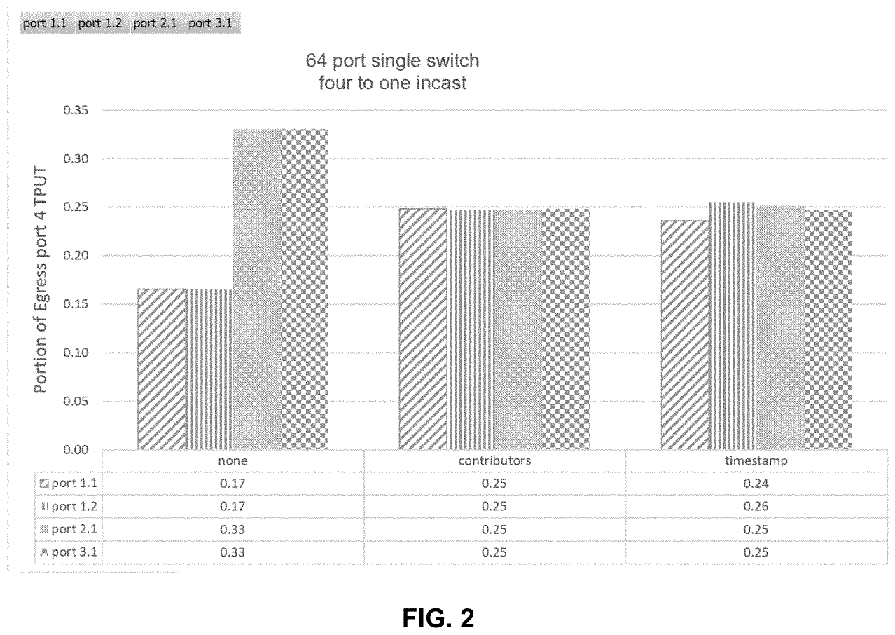

FIG. 2 shows bandwidth allocated to each ingress port for various schemes given the environment of FIG. 1. A baseline design assigns the same egress port bandwidth to each queue using ingress and egress arbiters (both use weighted fair scheduling). However, as shown, assigning the same static weight to each queue results in uneven allocation of bandwidth among input ports, which can cause congestion in ingress (input) ports and under-utilization of other input ports.

Another approach (approach 2) assigns egress bandwidth to each queue in proportion to the number of ingress ports that are sending traffic to that queue. For example, with respect to the example of FIG. 1, egress arbiter allocates two units of egress bandwidth to a queue that is fed by two ingress ports (1.1 and 1.2) and 1 unit of egress bandwidth to queues fed by ingress ports 2.1 and 3.1. But a number of ingress ports that feed a shared queue can change over time. If one port stops feeding a shared queue, it is difficult to determine when to reallocate bandwidth to the shared queue.

Yet another approach (approach 3) uses time stamps to determine which packet to egress whereby a packet with the oldest time stamp is egressed. As shown, approaches 2 and 3 provide a relatively balanced egress bandwidth allocation to each input port.

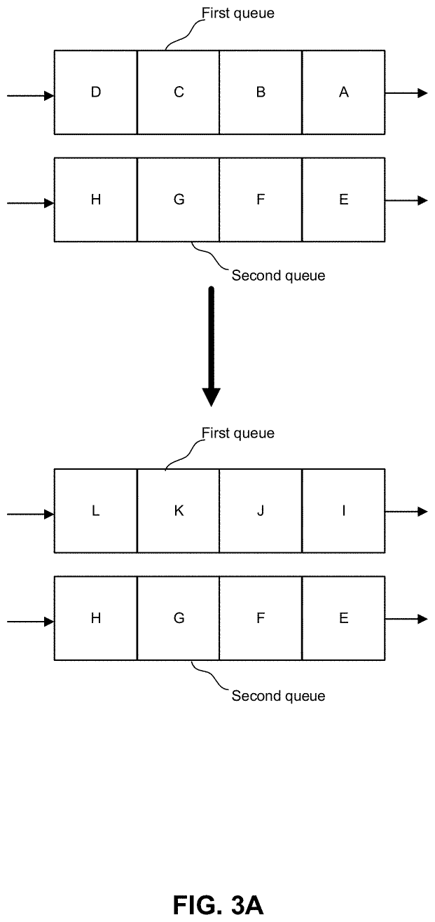

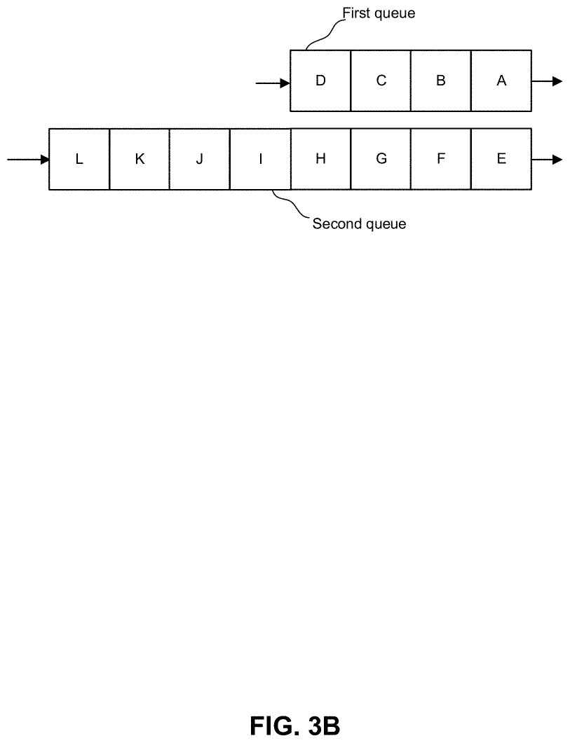

FIGS. 3A and 3B depict examples of egress based on packet time stamps. FIG. 3A depicts an example order of packet egress based on time stamps. In this example, there are two queues, a first queue and second queue and the first queue and second queue are the same size. Packets A-D are loaded into the first queue and packets E-H are loaded into the second queue. Packets A-H have an associated time stamp. Packet A is older than packet B, packet B is older than packet C, . . . packet G is older than packet H. An order of egress from the first queue is A, then B, then C, then D. The first queue is refreshed with packets I, J, K, L, where packet I is older than packet J, packet J is older than packet K, and packet K is older than packet L. Packet E, then F, then G, then H are egressed in order from the bottom queue. Then packets I, J, K, L are egressed in order. Accordingly, an order of egress is: A, B, C, D, E, F, G, H, I, J, K, and L. If first and second queues are the same size, then time stamp arbitration causes a same amount of bandwidth to be allocated the first and second queues.

FIG. 3B shows an example where the second queue is larger than the first queue. In practice, time stamp arbitration results in allocation of output bandwidth in proportion to queue depth. In this example, the second queue is twice as large as the first queue and accordingly, the second queue receives twice as much egress bandwidth as that of the first queue. Accordingly, even with use of time stamp arbitration, bandwidth is not allocated evenly to queues.

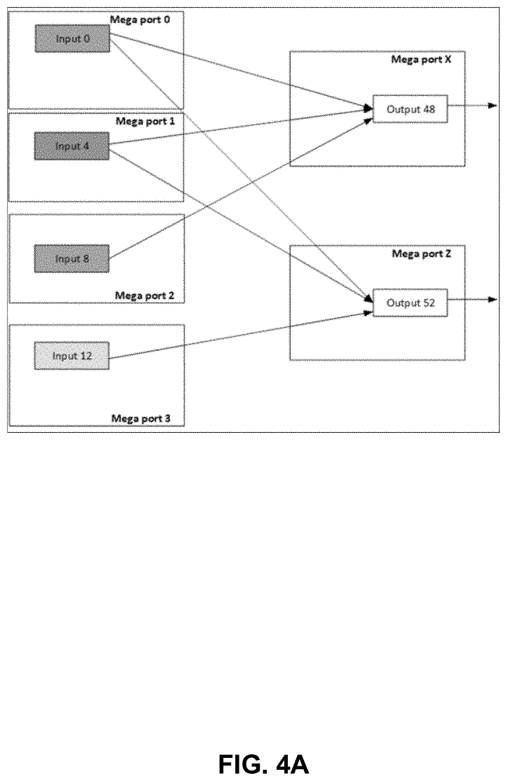

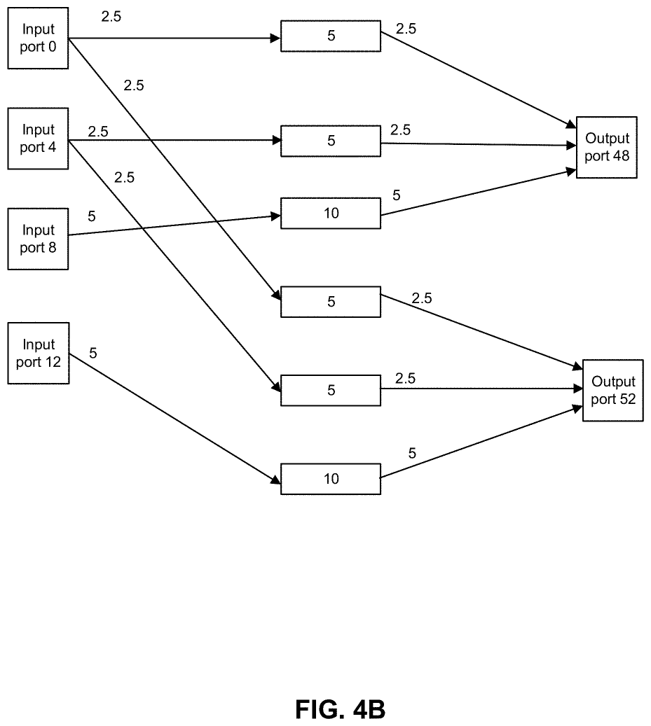

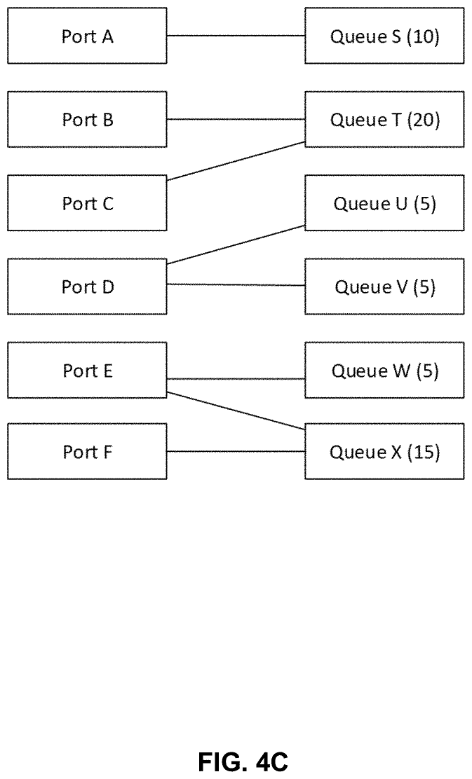

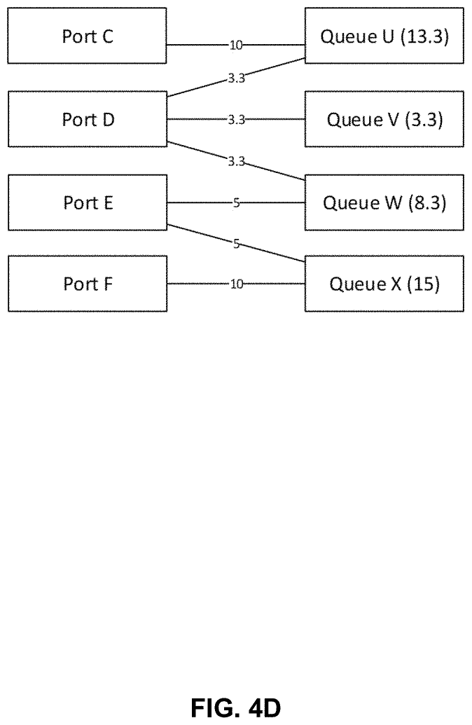

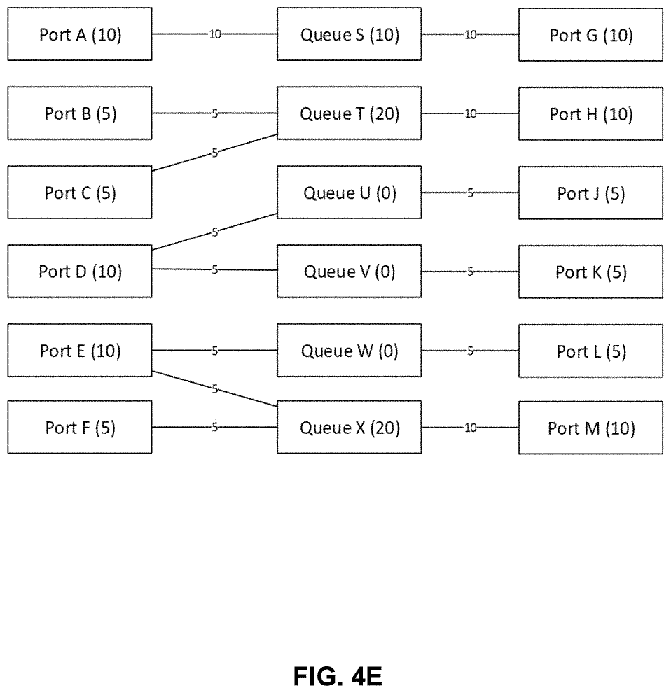

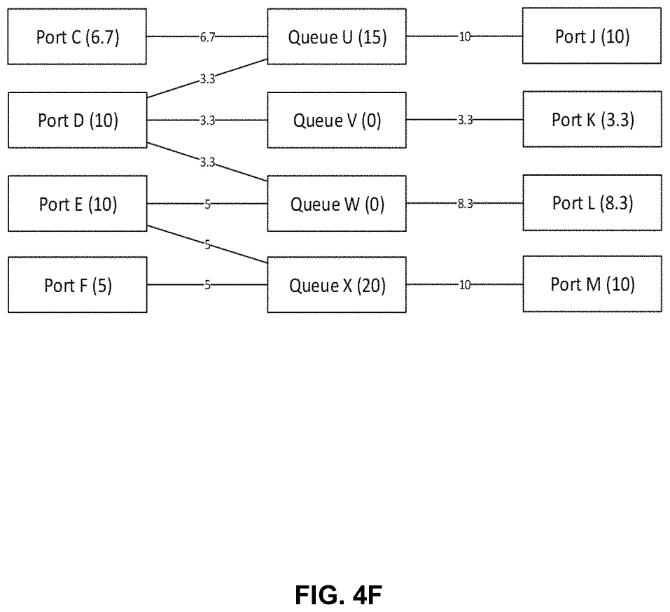

FIGS. 4A-4B depict an example of egress bandwidth allocation using time stamp arbitration. With time stamp arbitration, the number of destination output ports being targeted from an input port impacts an amount of bandwidth allocated to that input port by an egress arbiter. If a first ingress port sends packets to two output ports and a second ingress port sends packets to a single output port, then the first ingress port receives more egress bandwidth than the second ingress port under a round-robin scheme. With time stamp arbitration, all the inputs ports get same amount of bandwidth even though some of input ports send traffic to single or multiple output ports.

FIG. 4A depicts an example of egress bandwidth allocation for an incast scenario. Every arrow represents use of a queue to store packets prior to egress from an output port. Input port 0 supplies two different output ports and 50% of input port 0 traffic goes to output port 48 and 50% of input port 0 traffic goes to output port 52. Input port 4 supplies two different output ports and 50% of input port 4 traffic goes to output port 48 and 50% of input port 4 traffic goes to output port 52. Input port 8 supplies output port 48 whereas input port 12 supplies output port 52.

In this example, there are no port groupings and ingress ports do not share a queue. With round-robin arbitration, each of input ports 8 and 12 receives one-third output bandwidth of output ports 48 and 52, but input port 0 receives one-third output bandwidth of each of output ports 48 and 52. In this arrangement, input port 0 is throttled to outputting two-thirds of what could be supplied. And input port 8 is throttled to one-third output of what it could be supplying. Accordingly, an input port supplying multiple output ports leads to increased output bandwidth for that input port.

FIG. 4B shows how timestamp arbitration performs egress bandwidth allocation for the example of FIG. 4A. Input port 0 supplies packets to two queues whereby 50% of the bandwidth from input port 0 is supplied to a queue that supplies output port 48 and 50% of the bandwidth from input port A is supplied to a queue that supplies output port 52. Input port 4 supplies packets to two queues whereby 50% of the bandwidth from input port 4 is supplied to a queue that supplies output port 48 and 50% of the bandwidth from input port 4 is supplied to a queue that supplies output port 52. Input port 8 supplies packets to one queue that supplies packets to port 48.

Input port 12 supplies packets to one queue that supplies packets to port 52. If an output port has 10 units of bandwidth, then egress arbiter allocates bandwidth to intermediate queues proportionally as 2.5 units, 2.5 units, and 5 units. Input ports 0 and 4 split their bandwidth across the output ports. Every input port gets a total of 5 units of bandwidth. The bandwidth for input port 0 is a total of 5 units split across the two output ports (2.5 units for each output port). The bandwidth for input port 4 is a total of 5 units split across the two output ports (2.5 units for each output port). The bandwidth for input port 8 is a total of 5, all going to output port 48. The bandwidth for input port 12 is a total of 5, all going to output port 52.

FIG. 4C depicts an example of queue size allocation. Every input port is allowed 10 units of queue depth. Port A feeds queue S. Queue S is allowed to be depth 10. Ports B and C share queue T. Queue T is therefore allowed to be twice as large (depth 20). Port D feeds two separate queues U and V. Queues U and V share the space allocated for port D, so they are each 5 deep. Port E feeds Queues W and X while port F only feeds queue X. In this case, queue W is 5 units deep (half the allocation for port E). Queue X is 15 units deep (half the allocation for port E plus the full allocation of 10 from port F).

FIG. 4D depicts a scenario where each input port feeds a different number of queues, and each queue is fed by a different number of input ports. In the example of FIG. 4D, every input port is allowed 10 units of queue depth. Port C feeds queue U and provides 10 units of queue depth. Port D feeds queues U, V, and W and provides 3.3 units of queue depth to each of queues U, V, and W. Queue U is allowed to be depth of 13.3 units. Queue V is allowed to be a depth of 3.3 units. Port E feeds queues W and X. Queue W is allowed a depth of 8.3 units as 3.3 units is allocated by port D and 5 units is allocated by Port E. Port F feeds queue X. Queue X is allowed a depth of 15 units as 5 units is allocated by port E and 10 units is allocated by Port F.

FIG. 4E depicts a scenario with the edges showing the share of each input port going to a queue. Queues that drain faster can be smaller. In this example, input port A provide 10 units of queue depth to queue S which provides 10 units of queue depth to output port G. Output port G is exactly matched with input port A, so they are able to transfer data at the max rate of 10 units.

Output port H is oversubscribed, so queue T fills up. Queue T grows to its maximum size of 20 units of queueing (10 from each of input ports B and C). Output port H can only supply 10 units of bandwidth from queue T, so queue T can only admit 10 units of bandwidth. The bandwidth into queue T is shared fairly by input ports B and C. Input ports B and C each only get 5 units of bandwidth. Note that while the total bandwidth through ports B, C, and H is 10 units of bandwidth, the total queue depth is still 20 units of queue depth.

Input port D provides 5 units of queue depth to queue U and 5 units of queue depth to queue V. Output ports J and K collectively have more than enough available link speed to egress packets as fast as port D can populate its queues. Output ports J and K will egress packets out of queues U and V as soon as input port D provides packets. For this reason, queues U and V will be nearly empty (shown as 0) even though they are allowed to grow to 5 units of queue depth each.

Input port E provides packets to queues W and X. Queue W provides packets to output port L. Input port F provides packets to queue X only. Queue X provides packets to output port M. Output port L (like output ports J and K) is overprovisioned. Output port L can retrieve packets from queue W faster than input port E can push packets, so queue W will be nearly empty (shown as 0). This allows queue X to expand, using all of the available queuing resources for both ports E and F. The result is that input ports E and F are able to evenly share use of queue X and output port M.

Queues are virtual constructs which can grow and shrink on demand. The only constraint is on the total amount of queuing which can be allocated (limited by the size of the shared memory pool).

FIG. 4F depicts another example. Queue U could grow to 20 units (10 units from input port C and 10 units from input port D, since the other queues associated with input port D are empty). In that case, input ports C and D would share output port J evenly. However, input port D is not supplying enough packets to consume half of the bandwidth of output port J. Input port D only uses one-third of the bandwidth of output port J, so the remaining two-third of bandwidth goes to input port C. Since the feed rate of input port D is half that of input port C, input port D only needs 5 units of queueing space in queue U (hence the queue U has a size of 15).

Output ports K and L are overprovisioned (undersubscribed) and fetch packets from respective queues V and W faster than input ports D or E can push packets to queues V or W. Accordingly, queues V and W shrink to nearly empty (0). Queue X gets the full allocation from input ports E and F, which share output port M evenly.

Various embodiments provide a 1:1 mapping between a queue and an egress port. However, timestamp arbitration applied at an egress port allows for multiple queues to feed the same egress port and behave like a single queue since they are collectively first-in-first-out based on timestamp. Ingress ports which feed data to oversubscribed egress ports are only penalized based on the portion of their traffic which target those oversubscribed ports (like input port E of FIG. 4F). Queues that supply undersubscribed egress ports are mostly empty and do not count against the ingress port's queue allocation.

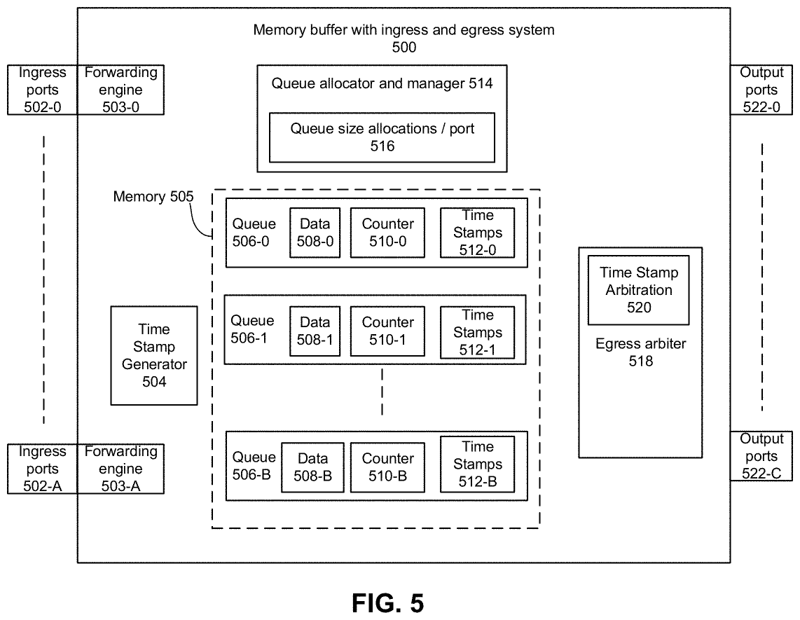

FIG. 5 depicts an example system to allocate a packet to a queue and egress packets. Various embodiments can be used in any network device. For example, a network device can be any of switch buffers, packet buffers, routers, network interfaces, or switches, or combination thereof. For example, a 25 Tbps switch can include up to 256 ingress and egress ports and support 16 traffic classes. Other speeds and numbers of ingress and egress ports can be supported. Memory buffer with ingress and egress system 500 receives packets from ingress ports 502-0 to 502-A, where A≥1, from a network medium, fabric, interconnect, bus, and so forth. For example, a network medium, fabric, interconnect, or bus can be compatible with one or more of: Ethernet, PCIe, Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, CCIX, and so forth.

Queue allocator and manager 514 determines a queue to allocate to a received packet. For example, a queue can be allocated based on flow, traffic class, level of fullness of one or more queues to load balance packets to less full queues, and so forth. Forwarding engine 503-0 to 503-A can copy a received packet (or portion thereof) to an allocated queue among queues 506-0 to 506-B, where B>1, in memory 505.

As noted above, some ports may receive a larger share of queueing space based on that port's bandwidth. Queue allocator and manager 514 can determine a maximum size of queues such that a size of a queue (queues 506-0 to 506-B) does not exceed an allocated region of memory for queues divided by a number of input ports that use the allocated region of memory. Queue size allocations per port 516 can indicate a maximum size of each queues 506-0 to 506-B. For example, for a 256 ingress port switch, at most 1/256 of memory 505 is allocated to each ingress port. An ingress port can supply a packet (or portion thereof) to one or more queues 506-0 to 506-B. For fewer ingress ports, larger maximum queue sizes can be allocated per ingress port. Queues can be constructed as lists that consume memory in shared memory. Maximum queue depth can be allocated per ingress port not port group.

In some embodiments, a single input port can use multiple queues to supply a single egress (output) port. However, a total size of the multiple queues used by the single input port to supply a single output port cannot exceed 1/NUMBER OF INPUT PORTS * shared memory size. Fairness across flows can be achieved latency insensitive queues (LIQs) using forwarding rules.

Memory 505 includes allocated queues 506-0 to 506-B. Queue 506-0 includes or is associated with data 508-0, counter 510-0, and time stamps 512-0. Data 508-0 can include data from packets received at an ingress port and allocated to queue 506-0. Meta data includes counter 510-0 and time stamps 512-0. Packet meta data can be tracked via tags which point to 1-256 bytes (or other sizes) of data stored in the global memory. Queues 506-1 to 506-B can also include or is associated with one or more of data 508, counter 510, and time stamps 512.

Queue size allocator and manager 514 can track a size of a queue based on allocated packets using counters 510-0 to 510-B for respective queues 506-0 to 506-B. Arrival of a segment of data at a queue causes a counter to increment. Queue size allocator and manager 514 does not let counter exceed 1/NUMBER OF INPUT PORTS * (shared memory size/segment size). If counter is to exceed 1/NUMBER OF INPUT PORTS * (shared memory size/segment size) with addition of the received packet or packet segment, then the queue is not permitted to add a data segment and the packet segment or packet can be dropped. In some examples, a segment of data is a uniform size. However, if a segment of data varies in size, then the total size of a queue can be capped at a total size (e.g., in bytes) and the counter counts accumulated size of data. The maximum size of a queue can be set as 1/NUMBER OF INPUT PORTS * (shared memory size). If a packet or packet segment egresses, queue size allocator and manager 514 decrements a counter for the queue from which the segment or packet egressed.

Time stamp generator 504 can generate a time stamp for a received packet at arrival at an input port or after copying to a queue (e.g., memory region). The timestamp can be an approximate timestamp. The time stamp for a packet can be stored in time stamps 512-0 to 512-B for queues 506-0 to 506-B. Time stamp generator 504 can determine a time stamp for group of one or more packets. For example, time stamp generator 504 can associate a timestamp with a block of 10-20 packet segments (or other numbers). A first tag in a block can be used to specify the timestamp of an entire block of packet segments.

In some examples, clock synchronization between network devices can occur using techniques described, for example, in IEEE 1588-2008 to synchronize timing to generate time stamps at packet transmission and/or at or after packet reception at a network device.

Egress arbiter 518 can egress packets from queues 506-0 to 506-B. Egress arbiter 518 can use time stamp arbitration 520 to egress packets by egressing oldest time stamp within a traffic class, flow, or other classification from any queue. Rather than compare all of the timestamps to find the oldest timestamp, egress arbiter 518 can scan the known timestamps until one is found which is older than the current timestamp. While the scan for a packet with an older timestamp among the queues is in progress, some number of packets may be scheduled for egress from the same queue from which a packet is egressed even though the packets do not have the oldest timestamp.

In some cases, timestamps do not have a fine granularity and multiple consecutive packets in a queue that arrived at different times may have the same timestamp value. In some cases, packet(s) with the identified oldest timestamp will egress before changing to a queue with even older packets. This may result in bursts of packets being output from the same queue.

To find an oldest timestamp, egress arbiter 518 can switch queues from which to select packets to egress. Egress arbiter 518 does not interrupt egress of a packet and after a packet has started output from a queue, the entire packet must be egressed before switching to a different queue.

In some examples, egress arbiter 518 can perform checking to determine if a timestamp provided with a received packet is fraudulent to cause faster egress. For example, a sender can provide a “back-dated” timestamp to packets to cause the packet to egress sooner than other packets with newer timestamps. For example, a code associated with valid timestamps and provided with a packet header can be checked by egress arbiter 518 to determine if the timestamp is authentic.

Consider output port J in FIG. 4F. If output port J were supplying bandwidth to another queue (in addition to queue U), bandwidth would have been allocated according to the actual queue depth (15 for queue U), not the maximum allowed queue depth (20 for queue U). Arbitration based directly on the queue depth can be called queue depth arbitration. This would have different characteristics from timestamp arbitration, as in the FIG. 4F/port J case. Queue depth arbitration can provide output bandwidth in proportion to maximum permitted queue depth. Setting a maximum permitted queue depth to be the same for all ingress ports can cause output bandwidth to be the same for ingress ports. With time stamp arbitration and setting a maximum size of each queue based on an allocation of memory for all queues divided by a number of ingress ports, all the inputs ports can receive the same amount of bandwidth even though some of input ports send traffic to single or multiple output ports.

In some examples, a queue depth can be changed to be actual queue depth to permit more bandwidth to fuller queues, but subject to the same maximum queue size.

Time stamp arbitration where each packet segment or packet is individually timestamped can provide an appearance of having a single shared output queue. In some examples, 16 input ports can share a queue, and egress arbitration chooses from 16 queues such that 256 input ports are supported (16*16=256).

In some embodiments, user-assigned weights can be applied per input port so the amount of egress bandwidth allocated to a queue equals the sum of the weights of the input ports feeding such a queue. Weighting does not have to be equal among the input ports.

After selection of an order of packet egress, output ports 522-0 to 522-C egress packets to a network medium, fabric, interconnect, bus, and so forth. For example, a network medium, fabric, interconnect, or bus can be compatible with one or more of: Ethernet, PCIe, Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, CCIX, and so forth.

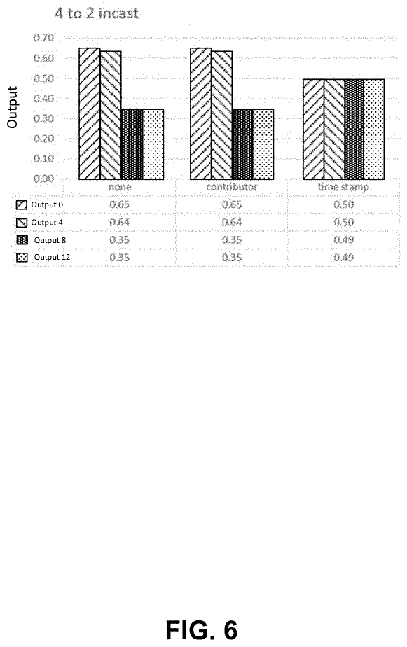

FIG. 6 shows the bandwidth consumed in a scenario of FIG. 4A. Ingress ports 0 and 4 send a portion of their traffic to two different egress ports. Ingress ports 8 and 12 only send traffic to one egress port (output port 48 or 52). FIG. 6 shows input ports 0 and 4 get approximately twice as much bandwidth as input ports 8 and 12 when using a baseline design that assigns the same egress port bandwidth to each queue using ingress and egress arbiters (both use weighted fair scheduling).

Another approach (contributor) assigns egress bandwidth to each queue in proportion to the number of ingress ports that are sending traffic to that queue. Ingress ports send traffic to only one queue. The arbiters for output port 48 and output port 52 are unaware of each other. Also, they are unaware that input ports 0 and 4 have two destinations while input ports 8 and 12 only have one destination. Output port 48 assigns its bandwidth evenly to the three input ports that drive it. Output port 52 does the same. Ultimately, input ports 0 and 4 receive approximately twice as much bandwidth as input ports 8 and 12 because they send packets to twice as many output ports.

However, use of time stamps to determine which packet to egress whereby a packet with the oldest time stamp is egressed can provide even egress bandwidth allocation among input ports.

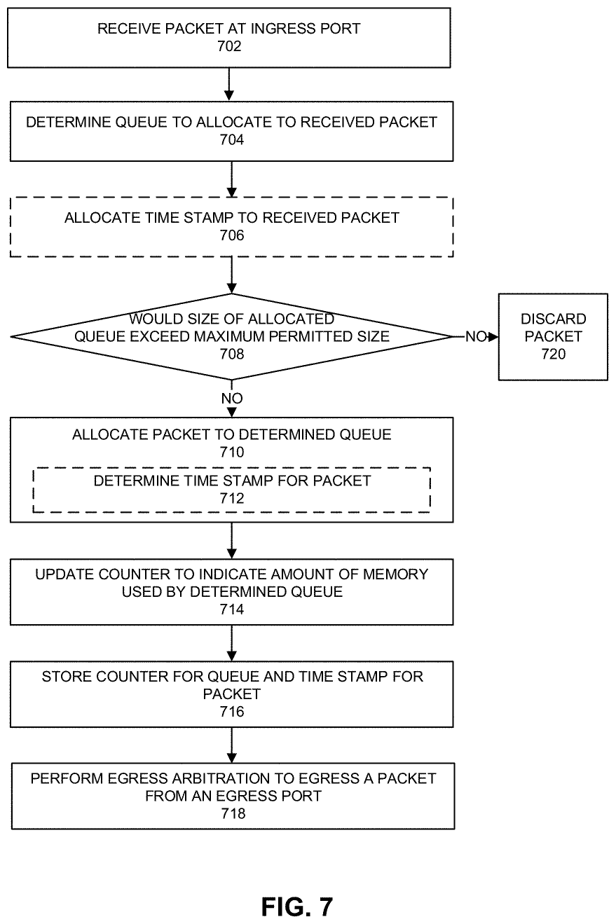

FIG. 7 depicts an example process. For example, the process can be performed by a switch or processors that manage receipt of packets to memory and transmission of packets from memory. At 702, a packet is received at an ingress port. The packet can be received from a network medium such as a network medium, fabric, interconnect, bus, or other device. The packet can be conveyed using any protocol including Ethernet, PCIe, Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, CCIX, and so forth.

At 704, a determination is made of a queue to allocate to the received packet at the ingress port. Allocation of queue to an ingress packet can be based on input port, flow, traffic class, or output port for the packet. A queue can be allocated in a region of memory and the region of memory can be shared for use by multiple ingress ports. In some embodiments, one or more queues can be allocated per input port and the one or more queues are associated with an egress port. The queue can be shared by one or more flows or traffic classes. For example, a flow can be identified by one or more of: a destination port, a destination IP address, a destination port, a destination IP address, or any other packet header, preamble, or payload contents.

At 706, a time stamp is allocated to the received packet. The time stamp can be assigned based on arrival time at an ingress port. A counter can be used to specify a time stamp. Allocation of a time stamp at 706 can be skipped if the time stamp is to be determined at or after writing of a packet (or portion of a packet) to a queue.

At 708, a determination is made as to whether a size of the allocated queue would exceed a maximum permitted size. A maximum size of a queue can be a size of the region of memory allocated for queues for one or more input ports divided by (number of ingress ports that use the region of memory). An ingress port is allocated to use a region of memory that is capped so that all ingress ports have the same maximum size use of the shared region of memory. If the queue size would exceed a maximum size with addition of the received packet (or portion thereof), 720 follows and the received packet (or portion thereof) is discarded and not stored in the allocated queue. In some examples, the received packet (or portion thereof) can be buffered in an intermediate queue and then discarded. If the queue size would not exceed a maximum size with addition of the received packet, 710 follows.

At 710, the received packet is allocated to the determined queue. A pointer to the received packet can be provided in the determined queue or the packet can be copied to a memory region corresponding to the determined queue via direct memory access (DMA) copy. In some examples, instead of or in addition to determination of a time stamp when the packet is received at an ingress port (706), at 712, the time stamp is determined when the received packet is copied to a determined queue.

At 714, a counter is updated for the queue allocated to the received packet. The counter can count number of packet stored in the queue or a total size of content in the queue. In some cases, a size of packet stored in the queue can vary from packet to packet and the counter counts a total size of memory used by the packets allocated to a queue. The usage counter for the allocated packet is updated to specify an amount of memory used by the allocated queue.

At 716, the usage counter can be stored in meta data for the associated queue in memory. At 716, the time stamp for the packet can be stored in meta data for the associated queue in memory and associated with a packet identifier.

At 718, egress arbitration is performed to egress a packet from an egress port. Egress arbitration selects a packet for egress from an egress port by selecting a packet with an oldest timestamp. Egress arbitration can select a packet from one or more queues for egress from an egress port. Egress of a packet causes a usage counter for the selected queue allocated to an egressed packet to be decremented to account for freed space in the memory region by egress of the packet.

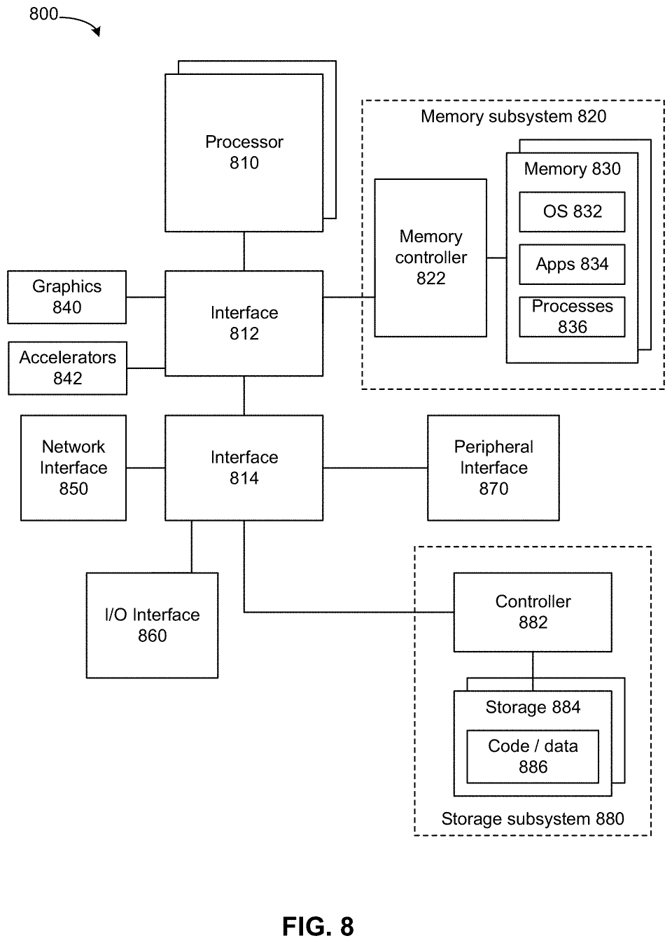

FIG. 8 depicts a system. The system can use embodiments described herein to provide data to or from the system to another device through a mesh or fabric. System 800 includes processor 810, which provides processing, operation management, and execution of instructions for system 800. Processor 810 can include any type of microprocessor, central processing unit (CPU), graphics processing unit (GPU), processing core, or other processing hardware to provide processing for system 800, or a combination of processors. Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a fixed function offload engine that can be accessed or used by a processor 810. For example, an accelerator among accelerators 842 can provide compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. Various embodiments can be used in connection with network interface 850, processor 810, and memory subsystem 820.

In one example, system 800 includes one or more input/output (I/O) interface(s) 860. I/O interface 860 can include one or more interface components through which a user interacts with system 800 (e.g., audio, alphanumeric, tactile/touch, or other interfacing). Peripheral interface 870 can include any hardware interface not specifically mentioned above. Peripherals refer generally to devices that connect dependently to system 800. A dependent connection is one where system 800 provides the software platform or hardware platform or both on which operation executes, and with which a user interacts.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (i.e., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (i.e., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 800. More specifically, power source typically interfaces to one or multiple power supplies in system 800 to provide power to the components of system 800. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 800 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

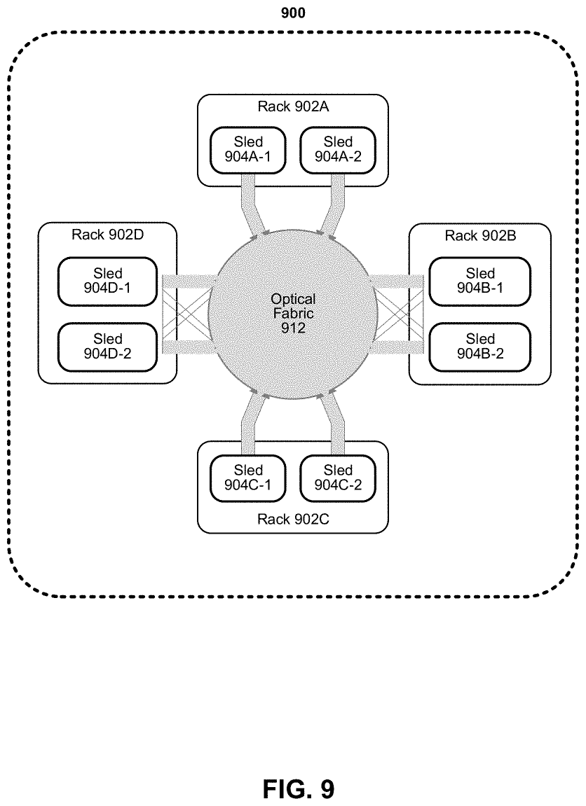

FIG. 9 depicts an example of a data center. As shown in FIG. 9, data center 900 may include an optical fabric 912. Various embodiments can be used in fabric 912. Optical fabric 912 may generally include a combination of optical signaling media (such as optical cabling) and optical switching infrastructure via which any particular sled in data center 900 can send signals to (and receive signals from) the other sleds in data center 900. The signaling connectivity that optical fabric 912 provides to any given sled may include connectivity both to other sleds in a same rack and sleds in other racks. Data center 900 includes four racks 902A to 902D and racks 902A to 902D house respective pairs of sleds 904A-1 and 904A-2, 904B-1 and 904B-2, 904C-1 and 904C-2, and 904D-1 and 904D-2. Thus, in this example, data center 900 includes a total of eight sleds. Optical fabric 912 can provide sled signaling connectivity with one or more of the seven other sleds. For example, via optical fabric 912, sled 904A-1 in rack 902A may possess signaling connectivity with sled 904A-2 in rack 902A, as well as the six other sleds 904B-1, 904B-2, 904C-1, 904C-2, 904D-1, and 904D-2 that are distributed among the other racks 902B, 902C, and 902D of data center 900. The embodiments are not limited to this example. For example, fabric 912 can provide optical and/or electrical signaling.

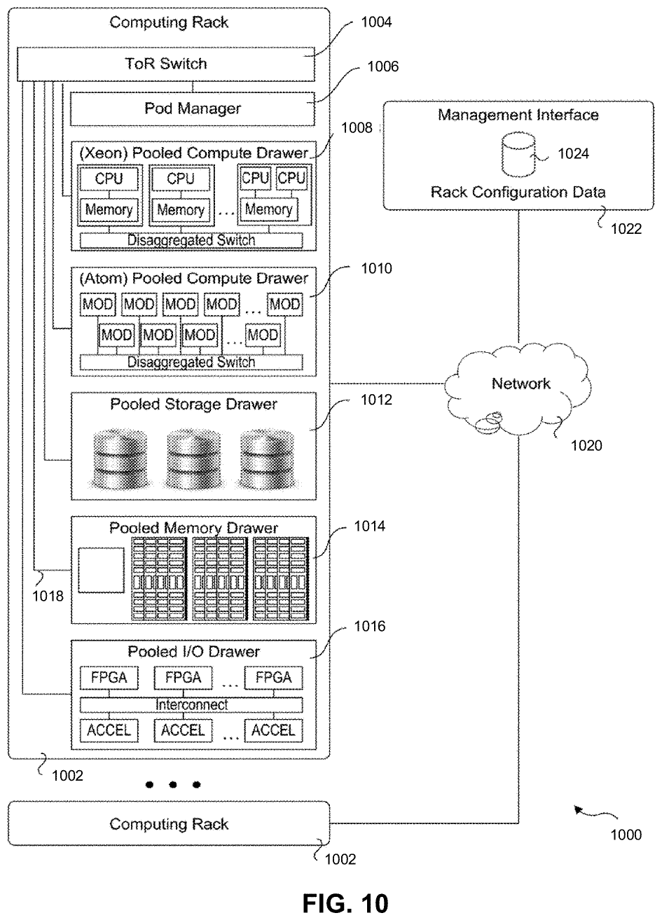

FIG. 10 depicts an environment 1000 includes multiple computing racks 1002, each including a Top of Rack (ToR) switch 1004, a pod manager 1006, and a plurality of pooled system drawers. Various embodiments can be used in a switch. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an INTEL® XEON® pooled computer drawer 1008, and INTEL® ATOMTM pooled compute drawer 1010, a pooled storage drawer 1012, a pooled memory drawer 1014, and a pooled I/O drawer 1016. Each of the pooled system drawers is connected to ToR switch 1004 via a high-speed link 1018, such as a 40 Gigabit/second (Gb/s) or 100 Gb/s Ethernet link or a 100+Gb/s Silicon Photonics (SiPh) optical link. In one embodiment high-speed link 1018 comprises an 800 Gb/s SiPh optical link.

Multiple of the computing racks 1000 may be interconnected via their ToR switches 1004 (e.g., to a pod-level switch or data center switch), as illustrated by connections to a network 1020. In some embodiments, groups of computing racks 1002 are managed as separate pods via pod manager(s) 1006. In one embodiment, a single pod manager is used to manage all of the racks in the pod. Alternatively, distributed pod managers may be used for pod management operations.

Environment 1000 further includes a management interface 1022 that is used to manage various aspects of the environment. This includes managing rack configuration, with corresponding parameters stored as rack configuration data 1024.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes a packet allocation apparatus in a network device, the apparatus including: a memory to store content associated with one or more queues; a queue allocator to allocate a portion of a received packet from an ingress port to one or more selected queues, wherein a maximum size of the one or more queues is a same maximum size as that allocated to one or more queues for another ingress port that stores content in the memory; a time stamp generator to generate a time stamp for a portion of the received packet; and an egress arbiter to egress packets from one or more queues in time stamp order.

Example 2 includes any example, wherein egress of packets from the one or more queues in time stamp order causes approximately even allocation of egress bandwidth among ingress ports.

Example 3 includes any example, wherein one or more queues are allocated to a single ingress port and a single egress port.

Example 4 includes any example, wherein the egress arbiter is to egress packets in one or more flows from one or more queues in time stamp order.

Example 5 includes any example, wherein the egress arbiter is to egress packets in one or more flows and one or more traffic classes from one or more queues in time stamp order.

Example 6 includes any example, wherein the time stamp generator is to: generate a time stamp for one or more received packets of any ingress port, flow, or traffic class and store the time stamp for one or more received packets in metadata for the one or more received packets.

Example 7 includes any example, wherein the time stamp generator is to: generate a time stamp for one or more received packets allocated to a queue and store the time stamp in metadata for one received packet of the one or more received packets.

Example 8 includes any example, wherein the time stamp generator is to generate a time stamp at a time of arrival at an ingress port or time when the received packet is copied to the allocated queue.

Example 9 includes any example, wherein the queue allocator is to: count an amount of packet data allocated to a queue and permit allocation of a portion of the received packet to a first queue among the one or more queues if a maximum size of the first queue is not exceeded, wherein the maximum size is (shared memory size)/(number of ingress ports that store content in the memory).

Example 10 includes any example, wherein the queue allocator is to allocate a portion of the received packet to a queue based on one or more of: input port, output port, traffic class, or flow.

Example 11 includes any example, wherein the memory is shared among multiple ingress ports.

Example 12 includes any example, wherein the egress arbiter is to allocate bandwidth in proportion to queue depth.

Example 13 includes any example, and includes one or more of: a switch, network interface, compute sled, rack, blade, server, or computing system.

Example 14 includes a method that includes selecting one or more queues for use by an ingress port among N ingress ports, wherein N≥1 and a maximum size of any queue of the one or more queues is a memory region size/N; allocating a portion of a packet received at an ingress port to a queue among the selected one or more queues if a size of the queue would not exceed the maximum size after addition of the received portion of the received packet; determining a time stamp to associate with the portion of the received packet; and selecting a packet to egress from an egress port based on a time stamp order.

Example 15 includes any example, wherein the one or more queues are allocated to a single egress port.

Example 16 includes any example, wherein the selecting a packet to egress from an egress port based on a time stamp order comprises selecting a packet among one or more flows to egress from an egress port based on an oldest time stamp.

Example 17 includes any example, wherein determining a time stamp to associate with the portion of the received packet comprises: generating a time stamp for one or more received packets allocated to a queue and storing the time stamp in metadata for one received packet of the one or more received packets.

Example 18 includes any example, wherein the time stamp comprises a time stamp at time of arrival at an ingress port or time when the received packet is copied to the selected queue.

Example 19 includes a network device system that includes a switch comprising one or more ingress ports and one or more egress ports; a memory; a queue allocator to allocate packets received at an ingress port to one or more queues, wherein the one or more queues are allocated to a single egress port and a maximum size of the one or more queues is a size of the memory allocated for use by the one or more ingress ports divided by a number of ingress ports that use the memory; a time stamp generator to generate a time stamp for a packet; and an egress arbiter to egress packets from one or more queues in time stamp order.

Example 20 includes any example, wherein the egress arbiter is to egress packets in one or more flows and one or more traffic classes from one or more queues in time stamp order.

Example 21 includes any example, wherein the time stamp generator is to: generate a time stamp for one or more received packets of any ingress port, flow, or traffic class and store the time stamp for one received packet in metadata for the one or more received packets.

What is claimed is:

1. A packet allocation apparatus in a network device, the apparatus comprising:
a memory to store content associated with one or more queues;
a queue allocator to allocate a portion of a received packet from an ingress port to one or more selected queues, wherein a maximum size of the one or more queues is a same maximum size as that allocated to one or more queues for another ingress port that stores content in the memory;
a time stamp generator to generate a time stamp for a portion of the received packet; and
an egress arbiter to egress packets from one or more queues in time stamp order.

2. The apparatus of claim 1, wherein egress of packets from the one or more queues in time stamp order causes approximately even allocation of egress bandwidth among ingress ports.

3. The apparatus of claim 1, wherein one or more queues are allocated to a single ingress port and a single egress port.

4. The apparatus of claim 1, wherein the egress arbiter is to egress packets in one or more flows from one or more queues in time stamp order.

5. The apparatus of claim 1, wherein the egress arbiter is to egress packets in one or more flows and one or more traffic classes from one or more queues in time stamp order.

6. The apparatus of claim 1, wherein the time stamp generator is to:
generate a time stamp for one or more received packets of any ingress port, flow, or traffic class and
store the time stamp for one or more received packets in metadata for the one or more received packets.

7. The apparatus of claim 1, wherein the time stamp generator is to:
generate a time stamp for one or more received packets allocated to a queue and
store the time stamp in metadata for one received packet of the one or more received packets.

8. The apparatus of claim 1, wherein the time stamp generator is to generate a time stamp at a time of arrival at an ingress port or time when the received packet is copied to the allocated queue.

9. The apparatus of claim 1, wherein the queue allocator is to:
count an amount of packet data allocated to a queue and
permit allocation of a portion of the received packet to a first queue among the one or more queues if a maximum size of the first queue is not exceeded, wherein the maximum size is (shared memory size)/(number of ingress ports that store content in the memory).

10. The apparatus of claim 1, wherein the queue allocator is to allocate a portion of the received packet to a queue based on one or more of: input port, output port, traffic class, or flow.

11. The apparatus of claim 1, wherein the memory is shared among multiple ingress ports.

12. The apparatus of claim 1, wherein the egress arbiter is to allocate bandwidth in proportion to queue depth.

13. The apparatus of claim 1, further comprising one or more of: a switch, network interface, compute sled, rack, blade, server, or computing system.

14. A method comprising:
selecting one or more queues for use by an ingress port among N ingress ports, wherein N≥1 and a maximum size of any queue of the one or more queues is a memory region size/N;
allocating a portion of a packet received at an ingress port to a queue among the selected one or more queues if a size of the queue would not exceed the maximum size after addition of the received portion of the received packet;
determining a time stamp to associate with the portion of the received packet; and
selecting a packet to egress from an egress port based on a time stamp order.

15. The method of claim 14, wherein the one or more queues are allocated to a single egress port.

16. The method of claim 14, wherein the selecting a packet to egress from an egress port based on a time stamp order comprises selecting a packet among one or more flows to egress from an egress port based on an oldest time stamp.

17. The method of claim 14, wherein determining a time stamp to associate with the portion of the received packet comprises:
generating a time stamp for one or more received packets allocated to a queue and
storing the time stamp in metadata for one received packet of the one or more received packets.

18. The method of claim 14, wherein the time stamp comprises a time stamp at time of arrival at an ingress port or time when the received packet is copied to the selected queue.

19. A network device system comprising:
a switch comprising one or more ingress ports and one or more egress ports;
a memory;
a queue allocator to allocate packets received at an ingress port to one or more queues, wherein the one or more queues are allocated to a single egress port and a maximum size of the one or more queues is a size of the memory allocated for use by the one or more ingress ports divided by a number of ingress ports that use the memory;
a time stamp generator to generate a time stamp for a packet; and
an egress arbiter to egress packets from one or more queues in time stamp order.

20. The system of claim 19, wherein the egress arbiter is to egress packets in one or more flows and one or more traffic classes from one or more queues in time stamp order.

21. The system of claim 19, wherein the time stamp generator is to:
generate a time stamp for one or more received packets of any ingress port, flow, or traffic class and
store the time stamp for one received packet in metadata for the one or more received packets.
